(19) United States
(12) Patent Application Publication
(10) Pub. No.: US 2014/0230810 A1
(43) Pub. Date: Aug. 21, 2014

(54) Apparatus And Method For Crystallization

(71) Applicant: FLORIDA CRYSTALS CORPORATION, West Palm Beach, FL (US)

(72) Inventors: Idalberto Delgado, Cutler Bay, FL (US); Stephen John Clarke, Royal Palm Beach, FL (US)

(73) Assignee: FLORIDA CRYSTALS CORPORATION, West Palm Beach, FL (US)

(21) Appl. No.: 14/183,851

(22) Filed: Feb. 19, 2014

Related U.S. Application Data
(60) Provisional application No. 61/766,994, filed on Feb. 20, 2013.

(51) Int. Cl. C13B 30/02

(52) U.S. Cl. CPC C13B 30/023
USPC 127/15; 127/58

(57) ABSTRACT

Apparatuses and methods are provided for crystallization. An apparatus includes a vessel defining an interior, a draft tube positioned in the interior of the vessel and defining an annular space between the draft tube and a side wall of the vessel, a rotor shaft extending along a central axis of the vessel, and a helical screw attached to and configured to rotate with the rotor shaft. A multi-stage apparatus further includes a stage barrier wall separating the vessel into two stages, with a draft tube and helical screw positioned in each of the stages. A method for crystallization includes supplying process material to be crystallized into a vessel, moving the process material through a central portion of the vessel, circulating a portion of the material through an annular space in the vessel, and discharging a portion of the material through an outlet.

### CROSS-REFERENCE TO RELATED APPLICATIONS

This application is a non-provisional of U.S. Provisional Application No. 61/766,994 filed Feb. 20, 2013, which is hereby incorporated by reference in its entirety.

### FIELD OF THE INVENTION

Provided are apparatuses and methods for crystallization. More particularly, apparatuses and methods are provided for efficiently mixing and cooling heavy massecuites.

### BACKGROUND OF THE INVENTION

Crystallization of solids from solution takes place from a supersaturated solution of the material, such as sucrose. Maintenance of supersaturation may be achieved by (i) removal of solvent by evaporation, or (ii) by cooling the solution. The first is standard practice in the sugar industry, although there are advantages to the general application of cooling crystallization. Supersaturated sugar solutions are viscous, and efficient cooling crystallization depends upon both good heat transfer and good mixing of the massecuite (mixture of crystals and the mother liquor). Up to now, equipment capable of meeting optimal heat transfer and mixing requirements has not been available.

Cooling crystallization has been used in the sugar industry for quite some time, but has not been the focus of much development. It has been considered of little importance where it is only applied to massecuites obtained via evaporative crystallization before their centrifugation, where it tends to be concentrated on the final crystallization stages; whereas front end exhaustion by cooling is given low priority, and little or no attention is paid on white sugar massecuite production. Historically, there have been limits to high purity massecuite exhaustion since, as the crystal content by mass increases, the massecuite becomes excessively viscous and leads to several mechanical problems: the massecuite cannot be removed from the pan and crystallizer in a reasonable time; the centrifugal cannot be properly and evenly loaded; the crystallizer cannot handle the viscous massecuite; and excessive sugar washing is required to reach sugar target purity, resulting in a purity rise across the centrifugal, which negates the benefits of additional crystallization. Additionally, traditional crystallizers have a tendency of having stagnant regions of massecuite that result in build-up of material in parts of the equipment.

Thus, there is a need in the art for apparatuses and methods for crystallization that are capable of increasing crystal content in massecuites in an effective and efficient manner while avoiding many of these downfalls.

### SUMMARY

In accordance with the purposes of this invention, as embodied and broadly described herein, this invention, in one aspect, relates to apparatuses for crystallization. An exemplary apparatus includes a vessel defining an interior having a lower portion and an upper portion, a draft tube positioned in the interior of the vessel and extending between the lower and upper portions. The draft tube can be spaced from the inner walls of the vessel, thereby defining an annular space between the draft tube and the side wall of the vessel. The apparatus can also include a rotor shaft extending along a central axis of the vessel, and a helical screw; the helical screw can be positioned in the interior of the vessel and within the draft tube and can be attached to and configured to rotate with the rotor shaft.

According to other embodiments, a multi-stage apparatus for crystallization is provided that includes a vessel having a central axis and defining an interior having a lower and upper portion. The apparatus can further include a first stage barrier wall that extends perpendicularly to the central axis of the vessel, the first stage barrier wall being positioned between the lower and upper portions and separating the vessel into a first stage and second stage, while providing at least one fluid passageway between the first stage and the second stage. A first draft tube can be positioned in the first stage of the vessel and can define an annular space between the first draft tube and the side wall of the vessel. Similarly, a second draft tube can be positioned in the second stage of the vessel and can define an annular space between the second draft tube and the side wall of the vessel. A rotor shaft can extend along the central axis of the vessel and can extend through the first and second stages of the vessel. A first helical screw can be positioned in the first stage of the vessel and within the first draft tube, and a second helical screw can be positioned in the second stage of the vessel within the second draft tube. The first and second helical screws can be attached to and configured to rotate with the rotor shaft. According to a further embodiment, the first and second helical screws can have opposite pitches.

According to yet other embodiments, a method for crystallization is provided that includes supplying process material to the vessel interior of apparatuses described herein, moving the process material through a central portion of the vessel, circulating at least a portion of the process material through an annular space in the vessel, and discharging at least a portion of the process material through an outlet of the vessel. For example, the method can include rotating the rotor shaft and helical screw to draw the process material from the lower portion to the upper portion of the vessel within the draft tube, circulating at least a portion of the process material through the annular space between the draft tube and side wall of the vessel, and discharging at least a portion of the process material through the outlet.

Additional advantages of the invention will be set forth in part in the description which follows, and in part will be obvious from the description, or may be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate several aspects of the invention and together with the description, serve to explain the principles of the invention.

FIG. 1 is a schematic diagram of an exemplary sugar production system that combines cooling crystallization with evaporative crystallization and backblending, according to one embodiment.

FIG. 2 is a schematic diagram of an exemplary sugar production system that combines cooling crystallization with evaporative crystallization and backblending, according to another embodiment.

FIG. 3 is a cross-sectional view of an apparatus for crystallization, according to one embodiment, with two stages in vertical arrangement.

FIG. 4 illustrates the flow of process material through the apparatus of FIG. 3.

FIG. 5 is a cross-sectional view of an apparatus for crystallization, according to one embodiment, with a single stage.

FIG. 6 illustrates the flow of process material through the apparatus of FIG. 5.

FIG. 7 illustrates the flow of process material through the apparatus of FIG. 5, with two stages in horizontal arrangement.

FIG. 8 is a graph showing the temperature profile with an apparatus for crystallization during a mixing test.

FIG. 9 is a graph showing the temperature profile within an apparatus for crystallization during the cooling and heating processes of the process material within the apparatus.

### DETAILED DESCRIPTION

The present invention may be understood more readily by reference to the following detailed description, examples, drawings, and claims, and their previous and following description. However, before the present devices, systems, and/or methods are disclosed and described, it is to be understood that this invention is not limited to the specific devices, systems, and/or methods disclosed unless otherwise specified, as such can, of course, vary. It is also to be understood that the terminology used herein is for the purpose of describing particular aspects only and is not intended to be limiting.

As used in the specification and the appended claims, the singular forms “a,” “an” and “the” include plural referents unless the context clearly dictates otherwise. Thus, for example, reference to a “stage” can include two or more such stages unless the context indicates otherwise.

Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

As used herein, the terms “optional” or “optionally” mean that the subsequently described event or circumstance may or may not occur, and that the description includes instances where said event or circumstance occurs and instances where it does not.

Reference will now be made in detail to the present preferred aspects of the invention, examples of which are illustrated in the accompanying drawings. Wherever possible, the same reference numbers are used throughout the drawings to refer to the same or like parts.

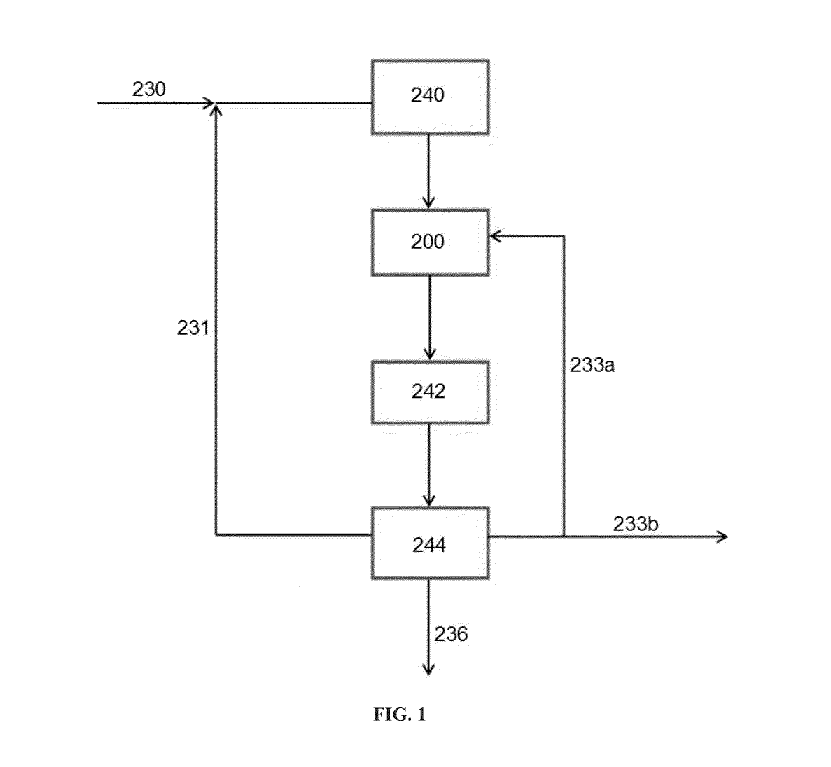

Provided are apparatuses and methods for crystallization, which can be used, for example, as part of a sugar production system. FIG. 1 illustrates an exemplary sugar production system, shown schematically, that combines cooling crystallization with evaporative crystallization and backblending. Primary feed 230 in addition to secondary feed 231 (comprised of cold white runoff) are fed to the pan 240. The massecuite then passes (shown by arrow 232) from the pan 240 to the crystallizer 200 (described in more detail below). In one embodiment, the cooling crystallization process is imposed on the massecuite to drop the massecuite from one temperature to another. In one particular embodiment, the cooling temperature profile is set to drop the massecuite from approximately 70° C. to approximately 30° C. As described further herein below, cold green runoff 233a can be provided to the crystallizer to lubricate the massecuite and remove excess crystal content, before the massecuite is passed to the centrifugal receiver 242 and thereafter to the centrifugal 244, to form the final sugar product 236. Any remaining cold green runoff 233b from the centrifugal, which is not used as lubricant in the crystallizer, is then passed to the next boiling stage.

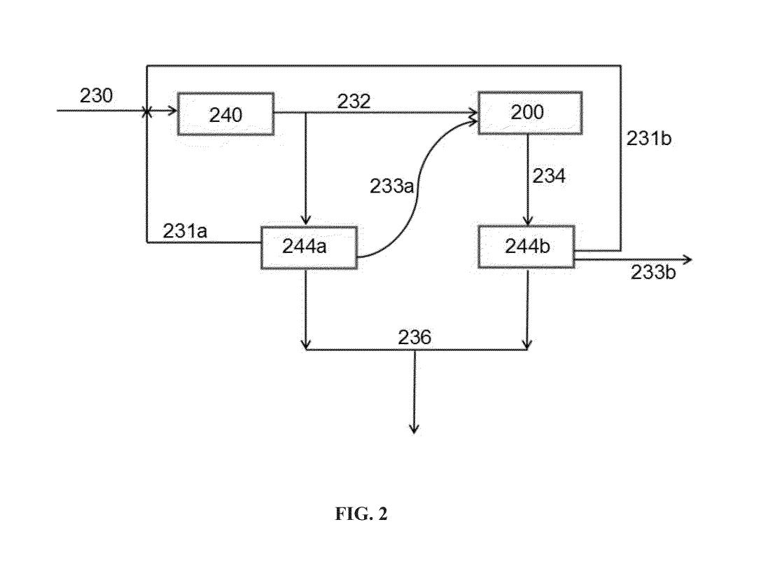

An optional exemplary system for sugar production that combines cooling crystallization with evaporative crystallization and backblending is shown in FIG. 2. In this system, a portion of the hot massecuite is centrifuged at strike. Primary feed 230 in addition to secondary feed (comprised of first cold white runoff 231a) are fed to the pan 240. Second white runoff 231b can also be fed to the pan. To lubricate the massecuite and remove excess crystal content, the first hot green runoff 233a from the first centrifugal 244a is returned to the remainder of the massecuite in the crystallizer 200; the second cold green runoff 233b from the second centrifugal 244b is passed to the boiling stage, as described above. This system differs from the system shown in FIG. 1, in that less massecuite passes through the crystallizer, thus decreasing the total crystallizer capacity needed, and the initial capital cost. However, for high purity massecuites (such as those used in refineries), there is a risk of sucrose crystallization occurring at the hot green runoff storage tank. Thus, two different tanks must be provided to handle both the first (hot) green runoff 233a, and the second (cold) green runoff 233b.

TABLE 1 shows the theoretical results of a pure sucrose massecuite produced in a pan, assuming that the mother liquor is saturated at 70° C. TABLE 1 also shows the results of the same massecuite, under the following conditions: (1) the mother liquor is saturated at 70° C., followed by a cooling crystallization process, reaching a saturated mother liquor at 30° C.; (2) the massecuite is lubricated in the crystallizer with cold undiluted (green) saturated mother liquor at 30° C., as shown in FIG. 1, or lubricated with hot undiluted (green) saturated mother liquor at 70° C., as shown in FIG. 2; and (3) 95% of the maximum calculated crystal solid yield is assumed. TABLE 1 shows that if the massecuite is subjected to the above conditions, the excess of crystal content achieved by the cooling crystallization can be removed. The lubricated cold massecuite shows similar rhealogical properties as the hot massecuite that was produced in the pan. Thus, both types of massecuite can be discharged from the crystallizer and loaded into centrifugal machines in the same manner without resulting mechanical problems.

TABLE 1

| | | Massecuite | Massecuite |
|---|---|---|---|
| | | lubricated | lubricated |
| | | with cool | with hot |
| | Massecuite | green | green |
| | from the | mother | mother |
| | pan | liquor | liquor |
| Massecuite mass (ton.) | 100 | 119 | 75 |
| Massecuite volume (ft³) | 2213 | 2630 | 1658 |
| Massecuite DS (%) | 90 | 86.56 | 86.56 |
| Massecuite | 70 | 30 | 30 |
| temperature (° C.) | | | |
| Mother liquor DS (%) | 76.4 | 68.48 | 68.48 |
| Mother liquor mass | 42.37 | 42.56 | 42.56 |
| fraction (%) | | | |
| Crystals mass fraction (%) | 57.63 | 57.44 | 57.44 |
| Crystal solid yield (%) | 64.0 | 66.4 | 66.4 |
| Mother liquor | 47.86 | 47.86 | 47.86 |
| volume fraction (%) | | | |
| Crystal volume fraction (%) | 52.14 | 52.14 | 52.14 |
| Mother liquor | 84 | 108 | 108 |
| viscosity (mPa · s) | | | |
| Massecuite viscosity (Pa · s) | 27.43 | 26.76 | 26.76 |
| Maximum crystal mass | 60.3 | 60.8 | 60.8 |
| fraction (%) | | | |
| Maximum crystal | 66.5 | 69.4 | 66.5 |
| solid yield (%) | | | |
| Maximum | 90.68 | 87.6 | 87.6 |
| massecuite | | | |
| DS (%) | | | |

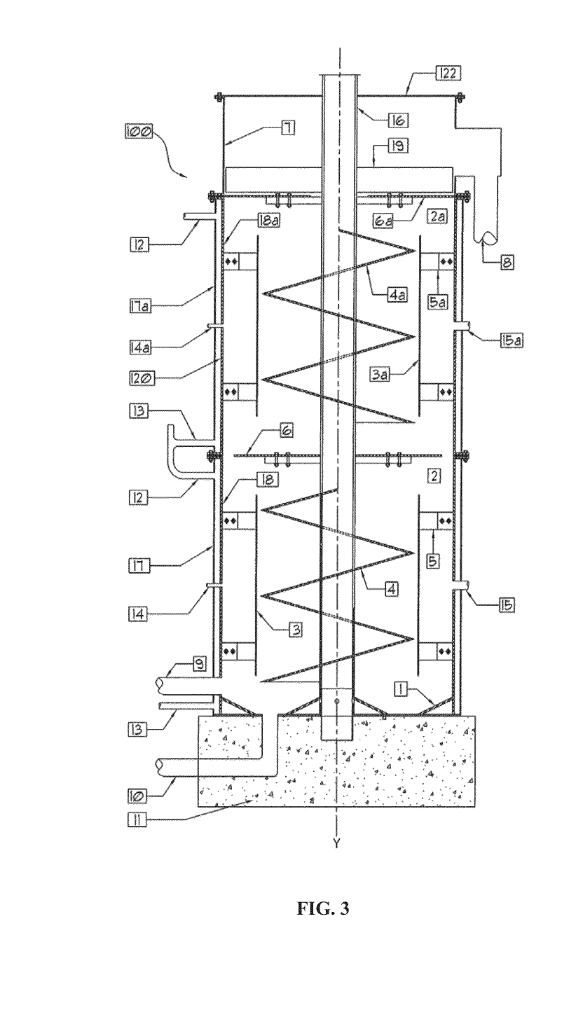

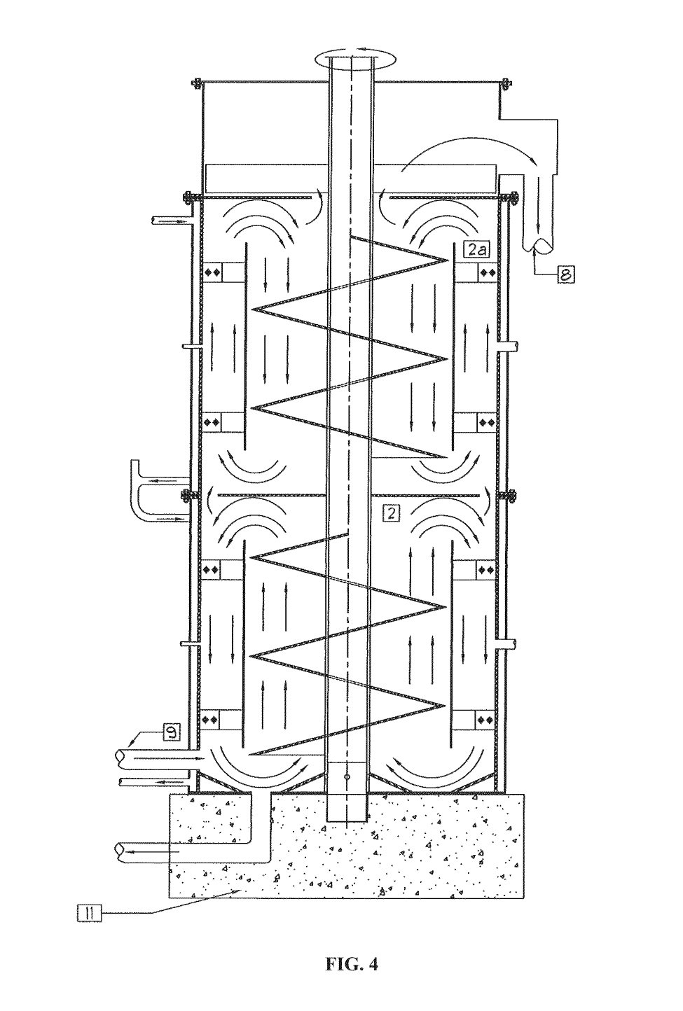

Referring now to FIGS. 3 and 4, a two-stage apparatus 100 in vertical arrangement for crystallization is provided, which comprises a vessel 120. The vessel 120 has a central axis y, a lower wall 1, and an upper wall 122. The vessel also has a side wall 18 that extends between the lower and upper wall. Thus, as seen in FIG. 3, the vessel defines an interior that generally has a lower portion proximate the lower wall and an opposed upper portion proximate the upper wall. In one embodiment, the vessel can be generally cylindrical. As can be seen in FIG. 3, the lower wall 1 can comprise several wall sections that are angled with respect to each other, such that the wall is not necessarily planar. For example, when viewed in cross-section (FIG. 3), the wall can, in one embodiment, have a general “W”-shaped profile. The apparatus 100, in one embodiment, can be built or positioned upon or within a foundation 11.

The vessel 120 comprises an inlet 9 for introduction of process material into the interior of the vessel. In one embodiment, the inlet can be positioned to be in direct fluid communication with the lower portion of the vessel. The vessel can also include an outlet 8 for discharge of the process material. The outlet can be positioned to be in direct fluid communication with the upper portion of the vessel, as shown in FIGS. 3 and 4.

In a further embodiment, the apparatus 100 comprises at least one draft tube, such as draft tubes 3, 3a, shown in FIG. 3. The draft tube can be positioned in the interior of the vessel and extend parallel to the central axis. However, the draft tube can be evenly spaced from the lower wall and the upper wall of the vessel. The draft tube can also be evenly spaced from the side wall of the vessel, thereby defining an annular space between the side wall of the vessel and an outer surface of the draft tube. In one embodiment, the draft tube can be connected to the side wall 18 of the vessel with the use of struts 5, 5a.

The apparatus 100 can also include a rotor shaft 16 that extends along the central axis y of the vessel, and at least one helical screw positioned in the interior of the vessel and within the draft tube. The helical screw is attached to and configured to rotate with the rotor shaft.

As shown in FIG. 3, the multi-stage apparatus 100 can also comprise at least one stage barrier wall 6 that extends perpendicularly to the central axis of the vessel. The stage barrier wall 6 can be positioned between the lower and upper portions, thereby separating the vessel into a first stage 2, and a second stage 2a. The stage barrier wall 6 can be positioned to provide at least one fluid passageway between the first stage 2 and the second stage 2a. For example, with reference to FIG. 3, the stage barrier wall 6 can be connected to and extend outwardly from the rotor shaft 16. However, with reference to FIG. 3, the stage barrier wall 6 can have a diameter that is less than the inner diameter of the vessel 120, such that a fluid passageway is provided between the stage barrier wall 6 and the side wall 18 of the vessel, thereby providing fluid communication between the first stage 2 and the second stage 2a of the apparatus.

A second stage barrier wall 6a can be provided to separate the second stage 2a from the upper portion 7 of the vessel. The second stage barrier wall 6a can be attached to and extend outwardly from the rotor shaft 16, as shown in FIG. 3. The second stage barrier wall 6a can have an outer diameter that is less than, but very close to the inner diameter of the vessel, and an inner diameter larger than the rotor shaft 16 diameter, such that a fluid passageway is provided between the inner diameter of the stage barrier wall 6a and the rotor shaft 16, thereby providing fluid communication between the second stage 2a and the upper portion 7. The upper portion 7 of the vessel comprises inclined paddle arms 19 that extend perpendicularly to the central axis of the vessel and can be connected and extend outwardly from the rotor shaft. As can be appreciated, if the stage barrier walls 6, 6a and the inclined paddle arms are attached to and extend from the rotor shaft, they will also rotate with the rotor shaft.

As described briefly above, the apparatus can include at least one helical screw that is attached to and configured to rotate with the rotor shaft. For example, in the multi-stage apparatus 100 shown in FIGS. 3 and 4, a first helical screw 4 is provided in the first stage 2, and a second helical screw 4a is provided in the second stage 2a. The first helical screw 4 is positioned within the first draft tube 3, and the second helical screw 4a is positioned within the second draft tube 3a. An exemplary helical screw has a length measured in a direction parallel to the central axis; similarly, the draft tube has a length measured in a direction parallel to the central axis. In one embodiment, the length of a helical screw is longer than the draft tube length. For example, as can be seen in FIGS. 3 and 4, the helical screw 4 extends slightly above and slightly below the full length of the draft tube 3.

In yet a further embodiment, in the case of a multi-stage apparatus, the first helical screw 4 and second helical screw 4a can have opposite pitches. As can be appreciated, when the rotor shaft rotates, the helical screws rotate in the same direction, but because of their opposing pitches, they effect fluid movement through the respective draft tubes in opposite directions from each other (as can be seen in FIG. 4).

Each helical screw has a respective flight diameter that in one embodiment is less than the inner diameter of a respective draft tube. In one embodiment the flight diameter is only slightly less than the inner diameter of the draft tube, such that only a small clearance is provided between the draft tube and the helical screw outer edges. For example, and not meant to be limiting, the flight diameter can range from approximately 93% to approximately 95% of the inner diameter of the draft tube. In yet a further embodiment, the pitch of each helical screw can be approximately half of the flight diameter.

According to other embodiments, the apparatus comprises heat exchange means for supplying heat to, or extracting heat from, the vessel. Whether the heat exchange means supplies heat to or extracts heat from the vessel would depend upon the preferred operating temperature of the vessel with at least one heat exchange means inlet port 12, 12a and at least one heat exchange means outlet port 13, 13a. For example, a jacketed housing can be provided to surround at least a portion of an apparatus component. As shown in FIG. 3, a jacketed housing 17, 17a is provided that surrounds at least a portion of the exterior of the vessel. Optionally, a jacketed housing can be provided that surrounds at least a portion of the exterior of the draft tube. In yet another embodiment, multiple jacketed housings could be provided, or additional jacketed housings can be positioned in the annular space between the draft tube and the vessel wall.

In other embodiments, temperature sensing means can be provided for sensing the temperature within at least a portion of the interior of the vessel. As shown in FIG. 3, thermocouples 14, 14a are provided to measure the temperature within each stage of the apparatus. However, other known temperature sensing means can be provided.

According to various embodiments, at least one lubricant inlet port 15, 15a can be provided to provide lubrication to each stage of the apparatus. The lubricant can be added to the process material or massecuite within the vessel in a technique known as backblending. This technique involves lubricating the massecuite with green runoff. Green runoff is primarily undiluted mother liquor, and white runoff is made up of some mother liquor together with washing from sugar plus centrifuge basket cleaning. In other embodiments, a liquid outlet port 10 can be provided to allow for the discharge of liquid from the apparatus.

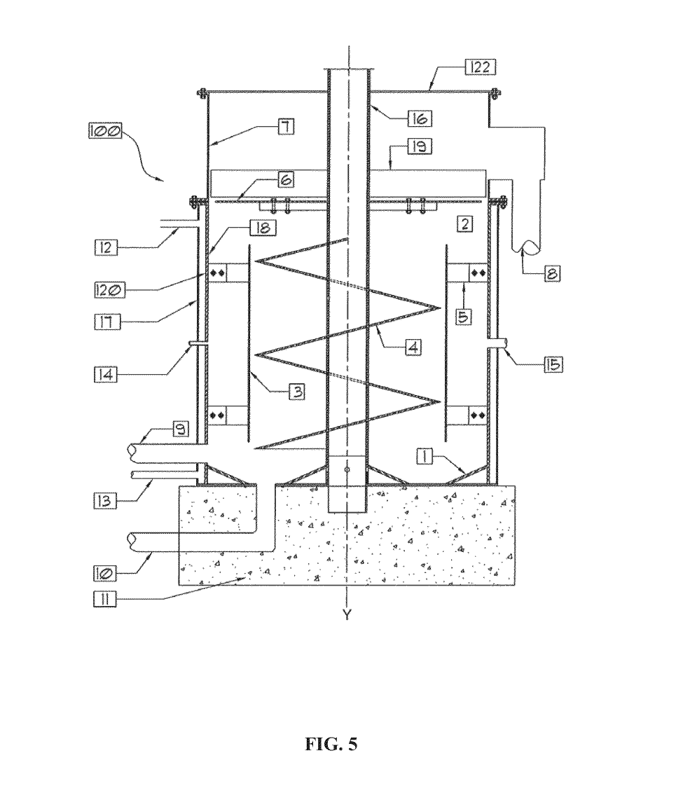

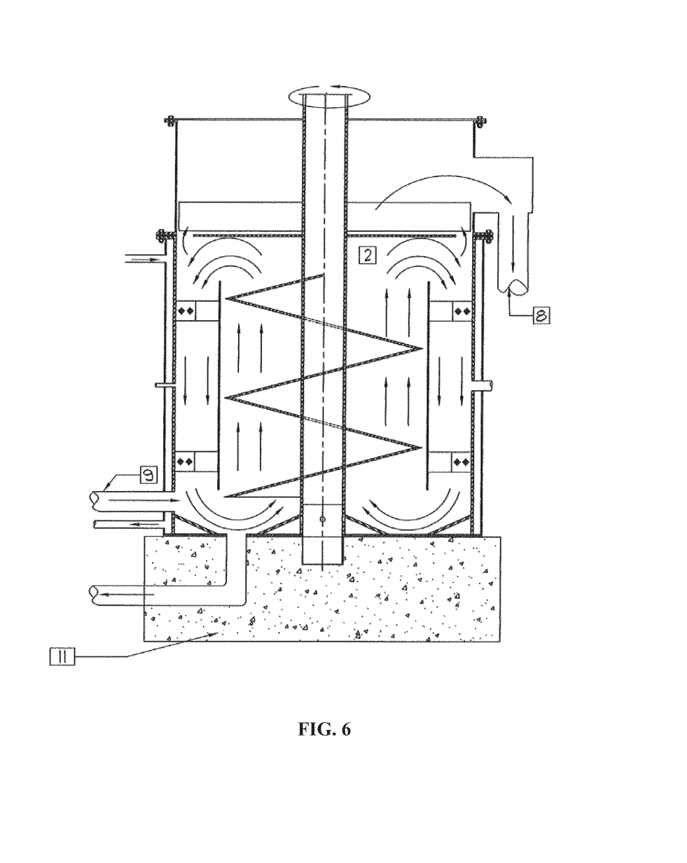

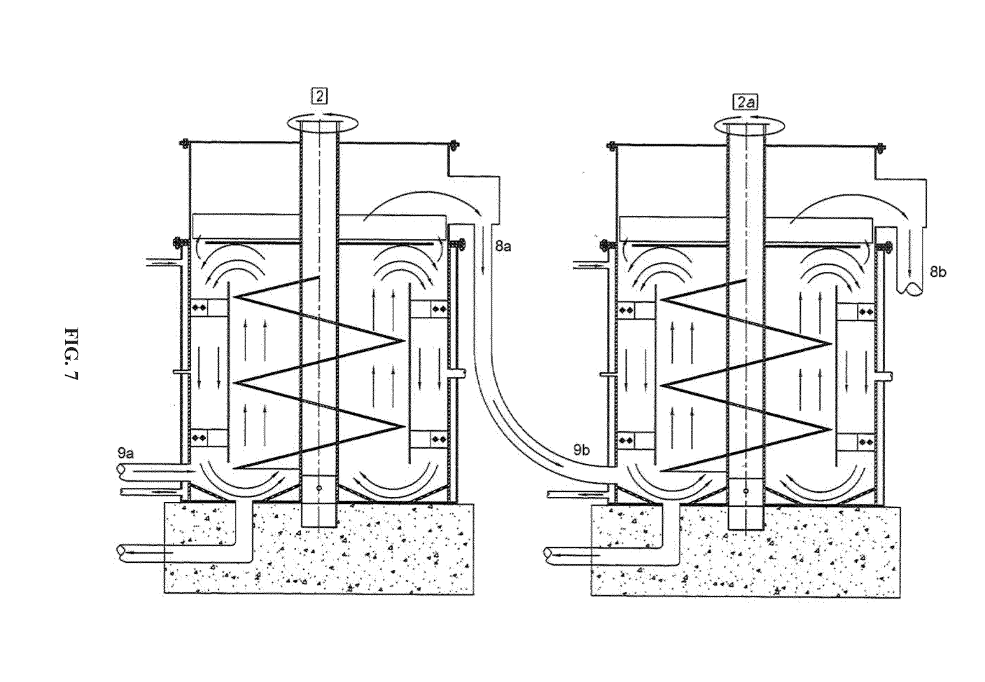

Although described above with reference to a two-stage apparatus 100 in vertical arrangement, such as shown in FIGS. 3 and 4, it is contemplated that the exemplary apparatuses described herein can be single stage (such as shown in FIGS. 5 and 6), or have more than two stages. For example, it can be appreciated that a single stage apparatus would have a vessel 120, a draft tube 3 positioned in the interior of the vessel, a rotor shaft 16, and a single helical screw 4, such as shown in FIGS. 5 and 6. In a multi-stage apparatus in vertical arrangement, additional stages could be positioned above the second stage 2a of the vessel 120 shown in FIG. 3, or multiple single-stage or multi-stage vessels could be provided in fluid communication with each other, as needed. For example, single-stage vessels in horizontal arrangement could be provided in fluid communication with each other, such as shown in FIG. 7, with the first stage 2 having an inlet 9a and a respective outlet 8a, which is in fluid communication with the inlet 9b of the second stage 2a; the second stage can have a respective outlet 8b.

It has been found that apparatuses for crystallization as described herein closely approach perfect mixing, with the process material entering the stage rapidly assuming a final uniform temperature and composition. The exit stream of process material from the stage has approximately the same temperature and composition as the process material within the stage. Within each stage, there is no build-up of stagnant process material along the vessel side wall or stage barrier walls. As discussed above, several stages can be connected in series to obtain a close approach to plug flow with all the process material entering in the first stage having the same average residence time at the outlet of the last stage.

Methods are also provided for crystallization using the apparatuses described herein. The method can include supplying the process material to the interior of a vessel, and moving the process material through a central portion of the vessel. At least a portion of the process material can be circulated through an annular space in the vessel. At least a portion of the process material can also be discharged through an outlet. More specifically, with reference to the apparatuses described herein, a single-stage crystallizer (such as shown in FIG. 5) can be provided having a vessel, a draft tube, a rotor shaft, and a helical screw. The process material can be supplied through the inlet to the vessel interior. The rotor shaft and helical screw can be rotated to draw or move the process material from the lower portion to the upper portion of the vessel within the draft tube. At least a portion of the process material can be circulating through the annular space defined between the draft tube and the side wall of the vessel. At least a portion of the process material can be discharged through the outlet. Such an exemplary flow pattern can be seen in FIG. 6.

Thus, it can be appreciated that a multi-stage apparatus can be used to perform a method for crystallization. Again with reference to FIG. 4, such a method can comprise passing at least a portion of the process material from the first stage to the second stage, via the fluid passageway defined between the first stage barrier wall and the vessel side wall. The method can further comprise circulating at least a portion of the process material through the annular space defined between the second draft tube and the side wall of the vessel. At least a portion of the process material can then be passed to the upper portion, and can be discharged through the outlet. Another portion of the process material can, alternatively, be drawn downward through the second draft tube.

### Experimental

The following examples are put forth so as to provide those of ordinary skill in the art with a complete disclosure and description of how the apparatuses, systems and/or methods claimed herein are made and evaluated, and are intended to be purely exemplary of the invention and are not intended to limit the scope of what the inventors regard as their invention. Efforts have been made to ensure accuracy with respect to numbers (e.g., frequency measurements, etc.), but some errors and deviations should be accounted for.

### EXAMPLE 1

A 1 ft³ batch crystallizer was manufactured, similar to the single-stage crystallizer described above. Three thermocouple probes were mounted at different levels within the vessel, at different radial distances from the rotor shaft, and on different sides of the vessel. These positions were selected to give as much information as possible about the mixing in the vessel. The process material selected was final massecuite, which is the material with the highest viscosity encountered in the sugar industry.

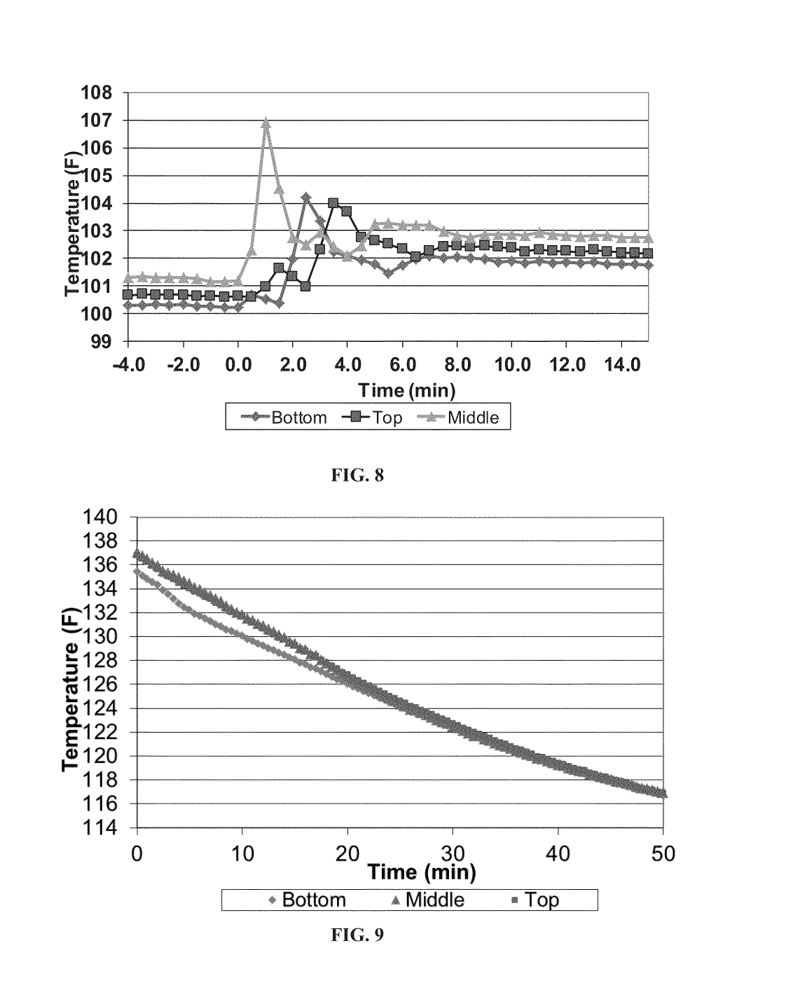

FIG. 8 shows the temperature profile with the four thermocouples when additional hot massecuite was added to the already-cooled massecuite.

During the cooling and heating processes of the process material selected, the temperature at different points of the vessel were monitored over time and the probe outputs were recorded and plotted as shown in FIG. 9. FIG. 9 shows that there are no significant differences among the thermocouple readings (the temperature differences between the four measurements were noted to be within the typical variation of measurements using thermocouples), which means that the process material was being mixed in a homogeneous manner with a uniform temperature and composition throughout the vessel. This behavior ensures that there are not deficiencies in vertical or tangential convection.

Thermocouple-based mixing tests were performed on the same batch unit with the same process material. The technique was based on the addition of a portion of the process material that has a different temperature from the bulk. Data collected by the thermocouples were processed to obtain a characteristic mixing time for the system under investigation. The data was first normalized to eliminate the effect of different probe gains. The mixing time is defined as the time required for the normalized probed outputs to read and remain between 99% and 101% (i.e., ±1%) of the final equilibrium temperature.

With reference to FIG. 8, the calculated mixing time was determined to be approximately 6 minutes. This time frame is approximately 20 to 50 times lower than the average resident time of the process material. This high ratio ensures a close approach to perfect mixing when the vessel is working in continuous operation. When several vessels are connected in series, a close approach to plug flow is obtained.

### EXAMPLE 2

Exhaustion of massecuites of different purities was carried out in batch operation in two crystallizers, made according to the single-stage crystallizer described above, sized to 1 ft³ and 12 ft³. A known amount of massecuite was taken from the pan at the strike, and was placed into a respective crystallizer. For high purity massecuite, to remove the excessive crystal content that is achieved when the mass is cooled and exhausted; a fraction of undiluted mother liquor was added. The massecuite was preheated to the strike temperature, and then cooled down following a scheduled temperature profile. Undiluted mother liquor samples were obtained by withdrawing a small quantity from the crystallizer and separating the mother liquor through C-centrifugal screen mesh, and then massecuites and nutsches were analyzed. The results are shown below for the different kind of massecuites:

Results: Mill High Purity Massecuite (1 ft³ Crystallizer)

| Sample | Purity | Purity Drop | Crystals Content |
|---|---|---|---|
| Massecuite, 0 hr., 70° C. | 86.8 | | |
| Mother Liquor, 0 hr., 70° C. | 70.3 | 16.5 | 55.6 |
| Mother Liquor, 5 hr., 40° C. | 61.9 | 24.9 | 65.4 |
| Mother Liquor, 6 hr., 40° C. | 60.4 | 26.4 | 66.7 |

Results: Mill High Purity Massecuite (12 ft³ Crystallizer)

| Sample | Purity | Purity Drop | Crystals Content |
|---|---|---|---|
| Massecuite, 0 hr., 70° C. | 80.86 | — | — |
| Mother Liquor, 0 hr., 70° C. | 61.69 | 19.17 | 50.04 |
| Mother Liquor, 4 hr., 40° C. | 51.99 | 28.87 | 60.13 |
| Mother Liquor, 5 hr., 40° C. | 51.78 | 29.08 | 60.31 |

Results: Mill Medium Purity Massecuite (1 ft³ Crystallizer)

| Sample | Purity | Purity Drop | Crystals Content |
|---|---|---|---|
| Massecuite, 0 hr., 70° C. | 65.1 | — | — |
| Mother Liquor, 0 hr., 70° C. | 45.6 | 19.5 | 35.8 |
| Mother Liquor, 16 hr., 37° C. | 37.3 | 27.8 | 44.3 |
| Mother Liquor, 16½ hr., | 37.8 | 27.3 | 43.9 |
| 50° C. | | | |

Results: Mill Medium Purity Massecuite (12 ft³ Crystallizer)

| Sample | Purity | Purity Drop | Crystals Content |
|---|---|---|---|
| Massecuite, 0 hr., 70° C. | 68.5 | — | — |
| Mother Liquor, 0 hr., 70° C. | 47.3 | 21.2 | 40.4 |
| Mother Liquor, 16 hr. 37° C. | 36.9 | 31.6 | 50.1 |
| Mother Liquor, 16½ hr., | 36.2 | 32.3 | 50.7 |
| 50° C. | | | |

Results: Mill Low Purity Massecuite (1 ft³ Crystallizer)

| Sample | Purity | Purity Drop | Crystals Content |
|---|---|---|---|
| Massecuite, 0 hr., 70° C. | 51.6 | | |
| Mother Liquor, 0 hr., 70° C. | 41.5 | 10.1 | 17.3 |
| Mother Liquor, 16 hr. 35° C. | 32.4 | 19.2 | 28.4 |
| Mother Liquor, 16½ hr. | 31.1 | 20.5 | 29.8 |
| 50° C. | | | |

Results: Mill Low Purity Massecuite (12 ft³ Crystallizer)

| Sample | Purity | Purity Drop | Crystals Content |
|---|---|---|---|
| Massecuite, 0 hr., 70° C. | 50.6 | — | — |
| Mother Liquor, 70° C. | 39.0 | 11.6 | 19.0 |
| Mother Liquor, 16 hr., 35° C. | 30.0 | 20.6 | 29.4 |
| Mother Liquor, 16½ hr., | 30.1 | 20.5 | 29.3 |
| 50° C. | | | |

Results: Recovery House High Purity Massecuite (12 ft³ Crystallizer)

| Sample | Purity | Purity Drop | Crystals Content |
|---|---|---|---|
| Massecuite, 0 hr., 70° C. | 90.60 | — | — |
| Mother Liquor, 0 hr., 70° C. | 82.71 | 7.91 | 45.63 |
| Mother Liquor, 2 hr., 40° C. | 78.52 | 12.08 | 56.24 |
| Mother Liquor, 4 hr., 40° C. | 78.03 | 12.57 | 57.21 |

Results: Recovery House Medium Purity Massecuite (1 ft³ Crystallizer)

| Sample | Purity | Purity Drop | Crystals Content |
|---|---|---|---|
| Massecuite, 0 hr., 70° C. | 66.30 | — | — |
| Mother Liquor, 0 hr., 70° C. | 52.80 | 13.50 | 28.60 |
| Mother Liquor, 2 hr., 40° C. | 49.70 | 16.60 | 33.00 |
| Mother Liquor, 4 hr., 40° C. | 47.90 | 18.40 | 35.32 |

Results: Recovery House Low Purity Massecuite (1 ft³ Crystallizer)

| Sample | Purity | Purity Drop | Crystals Content |
|---|---|---|---|
| Massecuite, 0 hr., 70° C. | 59.90 | — | — |
| Mother Liquor, 0 hr., 70° C. | 50.80 | 7.91 | 18.50 |
| Mother Liquor, 4 hr., 40° C. | 46.20 | 13.70 | 25.50 |
| Mother Liquor, 8 hr., 40° C. | 45.30 | 14.60 | 26.70 |

The results show that with both crystallizers (1 ft³ and 12 ft³), very close to the limit crystal content for both high and low purity grade massecuites were achieved. There was significantly improved heat transfer and mixing, and the time required to achieve the desired purity drop was much shorter than in conventional crystallizers. It was determined that evaporative crystallization, combined with cooling crystallization and backblending, can be used to reduce and simplify the number of crystallization stages in a raw sugar boiling scheme.

Taking into account the experimental data shown above, material and energy balances were calculated for a raw sugar double Einwurf four boiling scheme and for a two boiling scheme combined with cooling crystallization and backblending on high and low purity massecuites. Results are shown below.

By comparing the results, the advantages of the two boiling system can be seen as follows:
Flow of massecuites boiled in pans will be 30% lower. Commercial massecuite vacuum pans facilities will be lower by 30%.
Boiling house scheme will be simpler because only one commercial massecuite and one final massecuite must be boiled.
Greater steam economy (about 30% higher).
Commercial and final sugar quality will be improved, with less recirculation and hence reduced degradation and loss of sucrose in boiling, since the cooling crystallizer combined with evaporative crystallization can be used to reduce and simplify the number of crystallization stages.

Mass and energy balances were done for a four boiling white sugar scheme, and for a two boiling white sugar scheme with cooling crystallization and backblending.

TABLE 2

| Requires capacity | Two boiling | Four boiling |
|---|---|---|
| Pan capacity ft³/ton solids in fine liquor | 79.40 | 108.45 |
| Centrifugal capacity ft³/h/ton solids in fine | 41.69 | 43.38 |
| liquor | | |
| Crystallizer capacity ft³/ton solids in fine | 41.69 | 0 |
| liquor | | |
| Steam demand ton/ton solids in fine liquor | 44.47 | 56.43 |

TABLE 2 shows that if a two boiling white sugar scheme with cooling crystallization and backblending is compared with traditional four boiling white sugar scheme, the required pan capacity is 27% lower, the required centrifugal capacity is 3.9% lower, the required crystallizer capacity is 100% higher, and steam demand is 20% lower.

Materials and energy balances for the potential application of the “pure” cooling crystallization in white sugar production, using the apparatus for crystallization shown in FIGS. 3-7 were done. The results show that if “pure” cooling crystallization is adopted in the white sugar crystallization, 62% of the steam demand in evaporation and boiling house stages can be saved.

It will be apparent to those skilled in the art that various modifications and variations can be made in the present invention without departing from the scope or spirit of the invention. Other aspects of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. An apparatus for crystallization, comprising:
a vessel having a central axis, a lower wall, and upper wall, and a side wall extending between the lower and upper wall, the vessel further defining an interior having a lower portion and an upper portion, wherein the vessel comprises an inlet for introduction of process material into the interior, and an outlet;
a draft tube positioned in the interior of the vessel and extending between the lower portion and the upper portion parallel to the central axis, wherein the draft tube is spaced from the lower wall, upper wall, and side wall of the vessel, thereby defining an annular space between the draft tube and the side wall of the vessel;
a rotor shaft extending along the central axis of the vessel; and
a helical screw positioned in the interior of the vessel and within the draft tube, the helical screw being attached to and configured to rotate with the rotor shaft.

2. The apparatus of claim 1, wherein the inlet is positioned to be in direct communication with the lower portion, and the outlet is positioned to be in direct fluid communication with the upper portion.

3. The apparatus of claim 1, wherein the draft tube has an inner diameter, and wherein the helical screw has a flight diameter that is less than the draft tube inner diameter.

4. The apparatus of claim 1, wherein the draft tube has a length, and the helical screw has a respective length that is longer than the draft tube length.

5. The apparatus of claim 1 further comprising heat exchange means for supplying heat to or extracting heat from the vessel.

6. The apparatus of claim 5, wherein the heat exchange means comprises a jacketed housing positioned on and surrounding at least a portion of the exterior of the vessel.

7. The apparatus of claim 5, wherein the heat exchange means comprises a jacketed housing positioned on and surrounding at least a portion of the exterior of the draft tube.

8. The apparatus of claim 1, further comprising temperature sensing means for sensing the temperature within at least a portion of the vessel interior.

9. The apparatus of claim 8, wherein the sensing means comprises a east one thermocouple.

10. A multi-stage apparatus for crystallization, comprising:
a vessel having a central axis, a lower wall, and upper wall, and a side wall extending between the lower and upper wall, the vessel further defining an interior having a lower portion and an upper portion, wherein the vessel comprises an inlet for introduction of process material into the interior, and an outlet;
a first stage barrier wall extending perpendicularly to the central axis of the vessel, the first stage barrier wall being positioned between the lower and upper portions, wherein the first stage barrier wall separates the vessel into a first stage and a second stage, and wherein the first stage barrier wall provides at least one fluid passageway between the first stage and the second stage;
a first draft tube positioned in the first stage of the vessel and extending between the lower portion and the first stage barrier wall, wherein the draft tube is spaced from the lower wall, first stage barrier wall, and side wall of the vessel, thereby defining an annular space between the first draft tube and the side wall of the vessel;
a second draft tube positioned in the second stage of the vessel and extending between the first stage barrier wall and the upper portion, wherein the draft tube is spaced from the first stage barrier wall, the upper wall and the side wall of the vessel, thereby defining an annular space between the second draft tube and the side wall of the vessel;
a rotor shaft extending along the central axis of the vessel and extending through the first and second stages of the vessel;
a first helical screw positioned in the first stage of the vessel and within the first draft tube, the first helical screw being attached to and configured to rotate with the rotor shaft; and
a second helical screw positioned in the second stage of the vessel and within the second draft tube, the second helical screw being attached to and configured to rotate with the rotor shaft.

11. The apparatus of claim 10, wherein the first helical screw and second helical screw have opposite pitches.

12. The apparatus of claim 10, further comprising a second stage barrier wall extending perpendicularly to the central axis of the vessel, the second stage barrier wall being positioned between the second draft tube and the upper portion, and wherein the second stage barrier wall provides at least one fluid passageway between the second stage and the upper portion.

13. The apparatus of claim 10, wherein the first stage barrier wall is attached to and extends from the rotor shaft.

14. The apparatus of claim 12, wherein the second stage barrier wall is attached to and extends from the rotor shaft.

15. A method for crystallization of a process material, the method comprising:
supplying the process material into the interior of a vessel;
moving the process material through a central portion of the vessel;
circulating at least a portion of the process material through an annular space in the vessel; and
discharging at least a portion of the process material through an outlet of the vessel.

16. The method of claim 15, wherein the process material is massecuite.

17. The method of claim 15, wherein the vessel comprises a draft tube positioned in the interior of the vessel and extending between a lower portion of the vessel and an upper portion of the vessel parallel to a central axis, wherein the draft tube is spaced from a side wall of the vessel, thereby defining said annular space between the draft tube and the side wall of the vessel, wherein the step of moving the process material through a central portion of the vessel comprises moving the process material through the draft tube.

18. The method of claim 17, wherein the vessel further comprises a rotor shaft extending along the central axis of the vessel, and a helical screw positioned in the interior of the vessel and within the draft tube, the helical screw being attached to and configured to rotate with the rotor shaft, wherein the step of moving the process material through a central portion of the vessel comprises rotating the rotor shaft and helical screw to move the process material.
